(19) United States
(12) Patent Application Publication
(10) Pub. No.: US 2014/0014800 A1
(43) Pub. Date: Jan. 16, 2014

(54) Holster for displaying individual coin on vertical surface

(71) Applicants: Oscar H. Rojas, Bothell, WA (US); Martin Abbenhouse, Kirkland, WA (US); Gregory T. Kavounas, Bellevue, WA (US)

(72) Inventors: Oscar H. Rojas, Bothell, WA (US); Martin Abbenhouse, Kirkland, WA (US); Gregory T. Kavounas, Bellevue, WA (US)

(73) Assignee: ROHTEK, LLC

(21) Appl. No.: 13/573,374

(22) Filed: Sep. 12, 2012

Related U.S. Application Data
(60) Provisional application No. 61/741,191, filed on Jul. 16, 2012.

(51) Int. Cl. F16M 13/02

(52) U.S. Cl. 248/309.4; 248/309.1

(57) ABSTRACT

Devices and methods for supporting a coin, such as a challenge coin, on a vertical surface. A device includes a backing member and a base attached to the backing member. The backing member can be suspended substantially vertically on the vertical surface, for example using attaching means. The base can be arcuate. The coin can be placed on the base, and thus be supported by the device on the vertical surface. A letter of promotion can be framed, and the device can be attached to a front glass surface of the frame. This way, a coin such as a challenge coin can be displayed together with the letter of promotion.

### CROSS REFERENCE TO RELATED PATENT APPLICATIONS

This patent application claims priority from U.S. Provisional Patent Application Ser. No. 61/741,191, filed on Jul. 16, 2012, the disclosure of which is hereby incorporated by reference for all purposes.

### FIELD

This invention generally relates to apparatus for displaying a coin, such as a commemorative coin, a challenge coin, a collectors' coin, a medallion or medal, a silver dollar, a casino chip, and so on.

### BACKGROUND

In some instances, people want to display certain coins. Some such coins include commemorative coins, collectors' coins, medallions or medals, silver dollars, casino chips, and so on.

A challenge coin is a special type of a coin given by some organizations to their members, and typically bears the organization's insignia or emblem. In some instances, they are presented by a unit commander to a member in recognition of special achievement, or given upon a promotion to a new rank. When thus given, a challenge coin serves as a reminder of the trust that has been placed on the recipient for on-going responsibility to carry out service diligently and with honor. Challenge coins are often retained with pride, long after the service has ended.

There are a number of holders in the prior art for devices that will display coins, challenge coins, and other medallions. These include U.S. Pat. Nos. 2,844,248; 6,604,626; 6,896,127; 7,237,683; and 7,793,445, and US Published Patent Application Nos. 20080257756 and 20100293826.

Another holder for challenge coins in the prior art is case 900, depicted in FIG. 9. Case 900 is like a cabinet, for attaching to a vertical surface like a wall, and displaying many coins. The glass cover is openable, the coins are placed inside, and are visible through the glass cover. Case 900 is characterized as Military Challenge Coin Display Case Cabinet Holder Wall Rack w/ UV Protection, where it was found for sale in the website of www.amazon.com, prior to when this document was first filed with the USPTO.

### BRIEF SUMMARY

The present description gives instances of devices and methods, the use of which may help overcome problems and limitations of the prior art.

In one embodiment, a device is a holster, which includes a backing member and a base attached to the backing member. The backing member can be suspended substantially vertically on a host vertical surface, for example using attaching means. The base can be arcuate, for receiving and contacting at least three non-collinear points of a lower perimeter of an individual coin that is to be displayed. This way, the holster can support and display the coin, when the backing member is suspended on the host vertical surface.

In another embodiment, a method includes suspending a holster's backing member substantially vertically on a host vertical surface, for example using attaching means. Then the coin is placed on the holster's base, so that a lower perimeter of the coin is received and contacted by least three points on the arcuate base. This way, the holster can support and display the coin.

An advantage over the prior art occurs when the recipient of the coin also procures a frame for the letter of promotion associated with receiving the coin. The recipient can thus frame their document behind a glass, and hang the frame on a wall vertically. As such, the host vertical surface can be made from glass, behind which the document is framed. The holster can then be attached to the front glass surface of the frame, and the coin can thus be displayed together with the letter of promotion.

These and other features and advantages of this description will become more readily apparent from the following Detailed Description, which proceeds with reference to the drawings, in which:

### BRIEF DESCRIPTION OF THE DRAWINGS

FIG. 1A is a sectional side view of a holster suitable for being suspended on a host vertical surface, so as to display a coin, according to embodiments.

FIG. 1B is a front view of an embodiment of only an arcuate base of the holster of FIG. 1A.

FIG. 2 is a front view of an embodiment of only an arcuate base of a holster, in which the base is made of two base components.

FIG. 3 is a sectional side view of a holster, according to an embodiment where suspension is via an opening in the backing member.

FIG. 4 is a front view of a holster according to an embodiment where a backing member is substantially round, and has a diameter substantially equal to the diameter of a coin that is to be supported thereon.

FIG. 5 is a sectional side view of a holster that further includes a containing lip according to an embodiment.

FIG. 6 is a front view of a holster according to an embodiment where the base is made of two base components, and the lip is made of a plurality of lip components coextensive with the base components.

FIG. 7A is a front view of a holster according to an embodiment where the backing member has a cutout at the bottom of the substantially round shape.

FIG. 7B is a side view of the holster of FIG. 7A.

FIG. 8 is a flowchart for illustrating methods according to embodiments.

FIG. 9 shows the image of a case for displaying multiple challenge coins in the prior art.

### DETAILED DESCRIPTION

As has been mentioned, the present description is about devices and methods for displaying coins, such as challenge coins, on a vertical surface. Embodiments are now described in more detail.

Coins, including challenge coins, are typically shaped in the form of a round disk. Medallions and challenge coins are often somewhat larger than a coin used as currency.

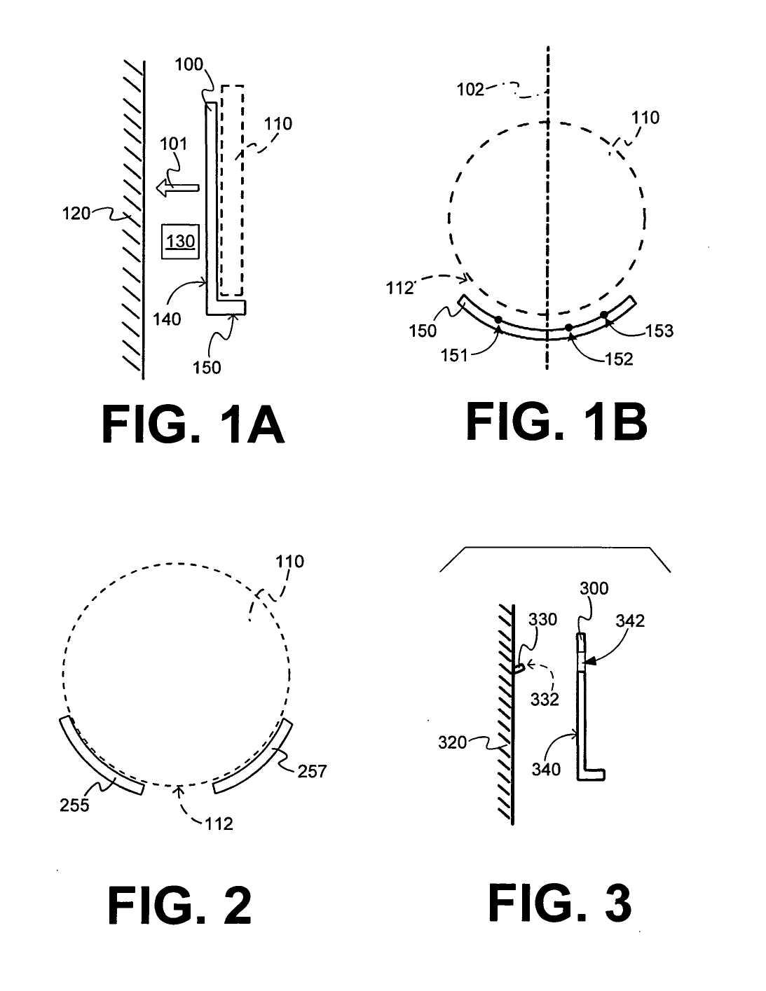

FIG. 1A is a sectional side view of a holster 100 for displaying an individual round coin 110 on a host vertical surface 120, made according to embodiments. Holster 100 is suitable for being suspended on surface 120. Holster 100 can be made from any suitable material. A preferred material is plastic.

Holster 100 includes a backing member 140. Backing member 140 can be implemented in any number of ways, such as a wire frame, a wire mesh, and so on. In preferred embodiments, backing member 140 is in the shape of a thin plate, which is also known as a backplate.

Backing member 140 is suitable for being suspended substantially vertically on surface 120. Suspending can be performed by bringing backing member 140 towards surface 120 according to arrow 101, and attaching it thereon via attaching means 130. Holster 100 also includes a base 150 attached to backing member 140. Base 150 is described in more detail below.

FIG. 1B is a front view of an embodiment of only arcuate base 150 of holster 100 of FIG. 1A. Strictly speaking, base 150 is arcuate for receiving and contacting at least three points 151, 152, 153 of a lower perimeter 112 of coin 110. This way base 150, and thus the entire holster 100 can support and display coin 110, when backing member 140 is suspended on surface 120.

Since perimeter 112 is curved, the three points 151, 152, 153 are disposed along a curved arc, and not a straight line. In other words, points 151, 152, 153 are non-collinear. Of course, points 151, 152, 153 are considered in the geometric sense as having no dimension, while in FIG. 1B they are shown as having a dimension only for illustration purposes. While base 150 only needs three points, such as points 151, 152, 153 for the invention, base 150 can have a different structure. For example, as seen in FIG. 1B, the entire base 150 can be shaped so that it receives and contacts the lower perimeter 112 substantially matingly. For planning this better, a vertical line 102 can be considered that passes through the center of where the coin will be placed, and so on.

In the embodiment of FIG. 1B, base 150 is unitary, meaning made from a single component. Other embodiments are now explored, where the base is segmented into base components.

FIG. 2 is a front view of an embodiment of only an arcuate base of a holster, in which the base is made of two base components 255, 257. Three or more contact points, not specially identified here, could be defined along base components 255, 257. Taken together, base components 255, 257 form an arcuate base for supporting coin 110 along its lower perimeter 112.

Returning to FIG. 1A, suspension of holster 100 on surface 120 can be accomplished in a number of ways, by proper implementation of attaching means 130. In some embodiments, attaching means 130 includes adhesive tape or glue. The active side of adhesive tape can be exposed by peeling off a film. In some embodiments, two-sided adhesive tape can be used. Indeed, such economical means can be used because the holster of the invention can be made lightweight, since it is intended for an individual coin. This is in contradistinction of the prior art of FIG. 9, which is intended for multiple coins.

In some embodiments, attaching means 130 includes a magnet. The magnet can be attached to backing member 140 either directly, or via the above-described adhesive tape. A magnet is suitable for suspending holster 100 on a metal surface, such as a metallic cabinet. Spaces for the military and other institutions especially have many metal surfaces, for example “Vidmar” type cabinets.

In some embodiments, attaching means 130 includes one or more needles. A needle can be pointing partly downward, for attaching holster 100 on the wall of a cubicle. The one or more needles can be attached to backing member 140 either directly, or via the above-described adhesive tape.

Other ways for attaching are now described.

FIG. 3 is a sectional side view of a holster 300 made according to an embodiment for suspending on a wall 320. Holster 300 has a backing member 340, and an opening 342 in backing member 340. The attaching means can be something that goes through opening 342. In an embodiment, such attaching means can include a thumbtack. In the shown embodiment, attaching means 330 includes a protrusion 332 from wall 320, such as a nail. Holster 300 can be suspended on wall 320 by bringing it close and aligning, so that protrusion 332 is received through opening 342.

In some embodiments, the backing member has a substantially round shape. In some of those embodiments, the backing member has a diameter substantially equal to a diameter of the coin. This is preferred, for suggesting to the user where the coin is to be placed.

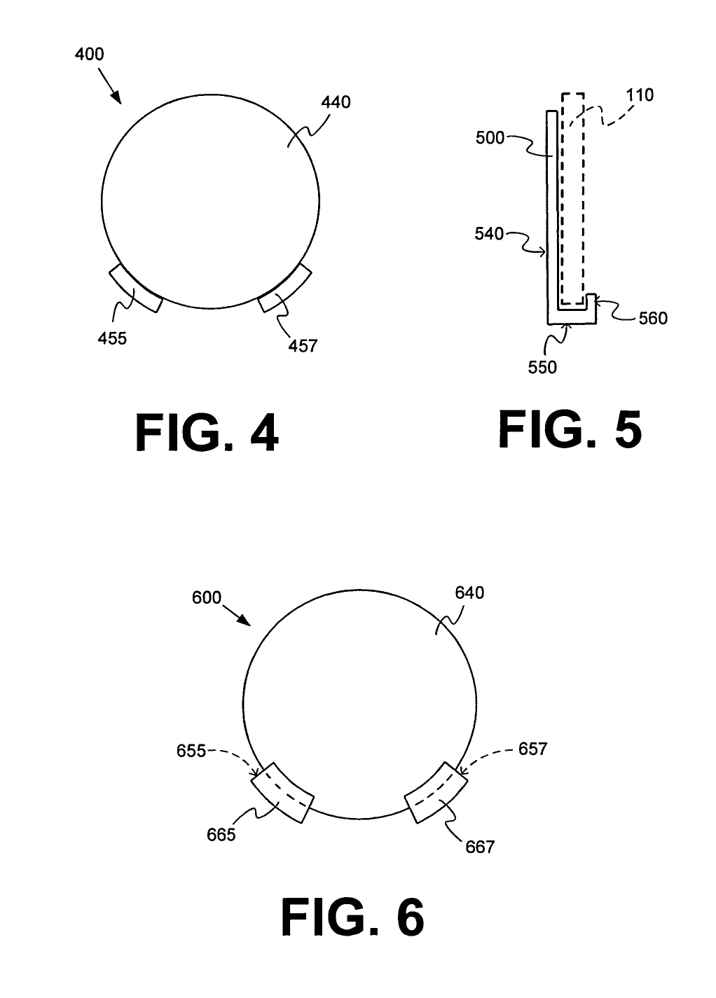

An example is shown in FIG. 4, where a holster 400 has a backing member 400 that is substantially round. In addition a diameter of backing member 440 is substantially equal to the diameter of a coin that is to be supported thereon by base components 455, 457.

FIG. 5 is a sectional side view of a holster 500 according to an embodiment that further includes a containing lip 560. More particularly, holster 500 includes a backing member 540 and a base 550. Containing lip 560 is attached to base 550. Lip 560 prevents coin 110 from falling off base 550, when the backing member 540 is suspended substantially on a vertical surface (not shown).

There are a number of possibilities for implementing the containing lip. In some embodiments, the backing member, the base and the containing lip are shaped so as to receive the coin substantially matingly. The containing lip can be substantially arcuate, like the base. One more possibility is described below.

There are a number of ways of measuring the height of lip 560. A first component of the height is how high, above and beyond base 550, lip 560 extends, in a way that obscures coin 110. That first component of the height is called the obscuring height. A second, optional component of the height is defined if lip 560 is considered to include the thickness of base 550. That second component of the height does not obscure displayed coin 110. Whether the second component of the height is included or not is only a matter of definition.

In preferred embodiments, the obscuring height of lip 560 is made as small as possible. This way, more surface of displayed coin 110 can be seen and appreciated. For example, obscuring heights are possible of no more than 3/8″, 1/4″, 1/8″, or even less. Small obscuring heights are possible where the coin is received substantially matingly.

FIG. 6 is a front view of a holster 600 that has a backing member 640, and a base made from two base components 655, 657. In the embodiment of holster 600, the lip is made of a plurality of lip components 665, 667, which are attached to, and coextensive with their respective base components 655, 657. In FIG. 6, lip components 665, 667 are in front of base components 655, 657, and thus obscure them.

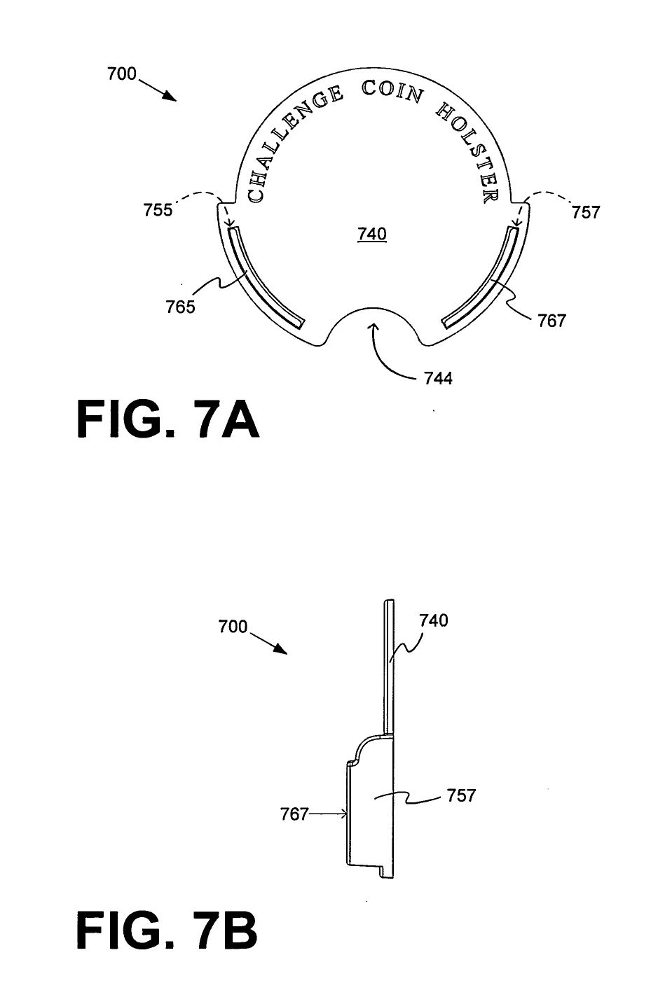

A preferred embodiment of a holster is shown in FIG. 7A and FIG. 7B. A holster 700 has a backing member 740, base components 755, 757, and lip components 765, 767. Lip components 765, 767 obscure base components 755, 757, similarly to what was shown in FIG. 6.

In addition, backing member 740 has a cutout 744 at the bottom of its substantially round shape. Upon seeing cutout 744, the user will know they can eventually remove the coin by pushing it up somewhat, with their finger moving up into cutout 744.

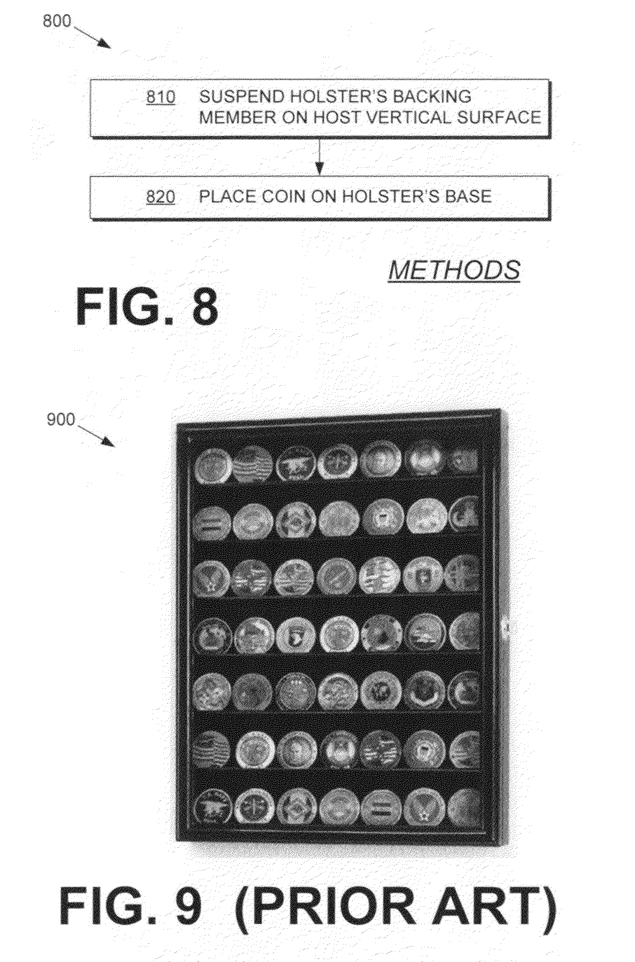

FIG. 8 shows a flowchart 800 for describing methods according to embodiments. The method of flowchart 800 may be practiced using a holster such as was already described above, for example holster 100.

According to an operation 810, the holster's backing member is suspended substantially vertically on a host vertical surface. Suspending can be via attaching means, as was described above.

According to a next operation 820, the coin is then placed on the holster's base, so that a lower perimeter of the coin is received and contacted by least three points of the arcuate base. This causes the holster to support and display the coin on the host vertical surface.

Then the coin can optionally be pushed upwards to be removed from the holster's base, and so on.

In this description, numerous details have been set forth in order to provide a thorough understanding. In other instances, well-known features have not been described in detail in order to not obscure unnecessarily the description.

A person skilled in the art will be able to practice the present invention in view of this description, which is to be taken as a whole. The specific embodiments as disclosed and illustrated herein are not to be considered in a limiting sense. Indeed, it should be readily apparent to those skilled in the art that what is described herein may be modified in numerous ways. Such ways can include equivalents to what is described herein. In addition, the invention may be practiced in combination with other systems.

The following claims define certain combinations and subcombinations of elements, features, steps, and/or functions, which are regarded as novel and non-obvious. Additional claims for other combinations and subcombinations may be presented in this or a related document.

What is claimed is:

1. A holster for displaying an individual round coin on a host vertical surface, the holster comprising:
a backing member suitable for being suspended substantially vertically on the host vertical surface via attaching means;
a base attached to the backing member, the base being arcuate for receiving and contacting at least three non-collinear points of a lower perimeter of the coin, so as to support and display the coin when the backing member is suspended on the host vertical surface; and
a containing lip attached to the base for preventing the coin from falling off the base, when the backing member is suspended on the host vertical surface.

2. The holster of claim 1, in which
the base is shaped so that it receives and contacts the lower perimeter of the coin substantially matingly.

3. The holster of claim 1, in which
the base is unitary.

4. The holster of claim 1, in which
the base is made of a plurality of base components.

5. The holster of claim 1, in which
the attaching means includes adhesive tape.

6. The holster of claim 1, in which
the attaching means includes two-sided adhesive tape.

7. The holster of claim 1, in which
the attaching means includes a magnet.

8. The holster of claim 1, in which
the attaching means includes one or more needles.

9. The holster of claim 1, in which
the attaching means includes a protrusion, and
the backing member includes an opening for receiving the protrusion therethrough.

10. The holster of claim 1, in which
the backing member has a substantially round shape.

11. The holster of claim 10, in which
the backing member has a cutout at the bottom of the substantially round shape.

12. The holster of claim 1, in which
the backing member, the base and the containing lip are shaped so as to receive the coin substantially matingly.

13. The holster of claim 1, in which
the containing lip is substantially arcuate.

14. The holster of claim 1, in which
the containing lip is made of a plurality of lip components.

15. The holster of claim 1, in which
the containing lip has a substantially uniform width along a coextensive portion of the base.

16. A method for displaying an individual round coin using a holster, the holster including a backing member that has a substantially round shape and a diameter substantially equal to a diameter of the coin, the holster further including an arcuate base attached to the backing member and a containing lip attached to the base, the method comprising:
suspending the holster's backing member substantially vertically on a host vertical surface via attaching means; and
then placing the coin on the holster's base so that a lower perimeter of the coin is received and contacted by least three non-collinear points of the arcuate base, for the holster to support and display the coin on the host vertical surface.

17. The method of claim 16, in which
the attaching means includes adhesive tape.

18. The method of claim 16, in which
the attaching means includes two-sided adhesive tape.

19. The method of claim 16, in which
the host vertical surface is made from glass, behind which a document is framed.

20. The method of claim 16, further comprising:
pushing the coin upwards to remove it from the holster's base.
